(19) United States
(12) Patent Application Publication
(10) Pub. No.: US 2024/0315271 A1
(43) Pub. Date: Sep. 26, 2024

(54) PROCESS FOR DECREASING TURBIDITY AND ACIDITY IN A COFFEE BEVERAGE

(71) Applicant: Basic Beverages LLC, Eastchester, NY (US)

(72) Inventors: Nicolas Blobel, Eastchester, NY (US); Samuel McDermott, Granville, NY (US)

(21) Appl. No.: 18/615,567

(22) Filed: Mar. 25, 2024

Related U.S. Application Data
(60) Provisional application No. 63/491,755, filed on Mar. 23, 2023.

(51) Int. Cl. A23F 5/14; A23F 5/20

(52) U.S. Cl. CPC A23F 5/145; A23F 5/202

(57) ABSTRACT

The invention pertains to a novel method for enhancing clarity and reducing the acidity of brewed coffee beverages. By incorporating potassium bicarbonate into either 1) roasted coffee beans (whole or ground) or 2) instant coffee granules, or 3) by providing potassium bicarbonate mixed with a carrier which can be added directly to brewed coffee, the turbidity of the resulting brewed coffee is significantly decreased, thereby improving its visual appeal. Additionally, the acidity of the brewed coffee is lowered, making it more palatable and potentially alleviating gastrointestinal discomfort often associated with acidic beverages. The process allows for customization based on the desired strength of the coffee and the chosen brewing method. This innovation presents a promising solution to enhance the overall quality and consumer satisfaction of coffee products.

### CROSS-REFERENCE TO RELATED APPLICATIONS

This application is a Utility patent application claiming priority to U.S. Provisional Patent Application Ser. No. 63/491,755, filed on Mar. 23, 2023, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The invention relates to the field of consumer beverages and, more specifically, to coffee beverages which are prepared with coffee beans, ground coffee beans or soluble coffee granules.

Further important background information includes the creation of soluble coffee. Soluble coffee, also termed instant coffee, is produced by brewing coffee and subsequently dehydrating it through freeze-drying or spray-drying methods. Instead of having to manage coffee grounds after extraction, consumers can add soluble coffee powder or granules directly to their cup, readily dissolving with water. While the quality of soluble coffee can fluctuate based on factors such as bean selection, brewing techniques, drying processes, and storage conditions, its acidity levels align with those observed in ground coffee bean extraction at around pH 5.0.

### Description of Related Art

Coffee enjoys widespread popularity in the United States, with a significant portion of the population consuming it daily. However, a common issue among coffee drinkers is gastrointestinal (GI) discomfort, often characterized by symptoms such as abdominal pain, bloating, and acid reflux, commonly known as heartburn. Notably, frequent coffee consumption ranks among the lifestyle factors reported by patients experiencing acid reflux.

The process of brewing coffee involves extraction of various substances and compounds from ground coffee through water dissolution, achieved via percolation, infusion, or pressure methods. Numerous factors, including water temperature, brewing duration, and coffee-to-water ratio influence the extraction profile and, consequently, the aroma, taste, and appearance profile of the resulting brew. There are many compounds extracted from coffee beans during the brewing process, including polyphenols (such as flavonoids, an antioxidant), lipids (such as triacylglycerols), and acids (such as chlorogenic, quinic, citric, malic acids). These compounds also all influence the taste, aroma, and appearance (e.g., clarity of the brewed coffee).

Due to the acids extracted from coffee beans, brewed coffee, regardless of brewing method, or whether consumed hot or cold, is an acidic beverage, with a pH around 5.0. In general, acidic foods are known as a trigger of GI distress, in particular acid-reflux and heartburn. Studies on heartburn and acid-reflux frequently monitor esophageal sphincter pressure as a common proxy for acid-reflux. A drop in this pressure is an indication of increased likelihood of acid-reflux, as the stomach acid is more likely to pass back through the esophagus via the esophageal sphincter. In a study by Thomas et al., “Inhibitory effect of coffee on lower esophageal sphincter pressure”, Gastroenterology, (1980), 1262-1266, 79(6), coffee with a pH of 4.5 led to a stronger drop in sphincter pressure than coffee at a neutral pH of 7, suggesting that the acidity in coffee could be a cause of heartburn and acid-reflux. Thus, by neutralizing the acidity of coffee by increasing the pH, acid-reflux and heartburn symptoms could be lessened.

Many individuals currently alleviate acid reflux symptoms by consuming antacids, formulations most frequently containing acid-neutralizing compounds like calcium carbonate. These compounds function by counteracting acidity in the stomach, providing relief to affected individuals. Many common brands contain calcium carbonate as their active ingredient, and recommended use doses most frequently range from 500 mg-1000 mg.

A few non-medicinal methods have been developed to lower the acidity of coffee prior to consumption. This includes methods described by an existing patent U.S. Pat. No. 6,495,180B1. This patent includes the use of specific supplements as acid-neutralizing agents: calcium carbonate, potassium hydroxide, and magnesium hydroxide, which all have significant disadvantages. In the case of sodium bicarbonate, the presence of sodium (Na⁺) gives the beverage a salty flavor, strongly impacting the flavor in an adverse fashion. Calcium carbonate is not readily water soluble and often remains as a white precipitate after being added to the beverage. Calcium carbonate is useful as an antacid, as it dissolves more readily in acidic environments such as in the stomach, where the pH is between 1.5-3.5. However, due to its relative insolubility in water, it is not useful as an acidity-neutralizer in water-based beverage applications. Both potassium hydroxide and magnesium hydroxide are strong bases and require increased caution as they can be harmful to both those manufacturing and those consuming the product if not used appropriately. There remains a need in the art for a method that can lower the acidity of coffee and other beverages that is a known safe substance, effectively lowers the brewed or reconstituted coffee's acidity while causing the least possible change in flavor and overall quality of the beverage.

Furthermore, when coffee is prepared by the conventional method of extraction with hot water, the resulting brewed coffee becomes increasingly turbid and less clear as the temperature decreases. Turbidity is a measure of the cloudiness or haziness of a fluid. In the context of coffee, turbidity can affect the appearance of the beverage and potentially its taste and aroma. This increase in the turbidity of coffee with decreasing temperature can be seen in the turbidity measurements (Nephelometric Turbidity Units, NTU) of brewed coffee at its typical non-adjusted base pH of 5.0. As shown in FIG. 1, the turbidity of typical coffee at 52° C. (126° F.) measures 1.94 NTU (110), which increases to 4.00 NTU when cooled to 8° C. (46° F.) (110). Visually, this difference in turbidity manifests as a noticeable decrease in the clarity of the brewed coffee, leaving the consumer with a potentially unappealing ‘murky’ coffee.

Here, we describe our process of the addition of potassium bicarbonate to coffee beans (ground or whole bean) or soluble coffee, prior to the brewing process or after the coffee is brewed to lower both the acidity and turbidity of the brewed coffee. Potassium bicarbonate is an ideal compound for this purpose, being safe to handle (compared to hydroxide bases, see 0010), readily soluble in water-based beverages (compared to calcium carbonate, see 0010), and lacking off flavors (compared to sodium bicarbonate, see 0010).

### SUMMARY OF THE INVENTION

The present invention addresses challenges within the beverage industry, particularly focusing on mitigating both the turbidity and acidity of brewed coffee. Two distinct applications are proposed herein with two unique implementations of the invention. In the first application, potassium bicarbonate [KHCO3] is introduced to roasted coffee beans, whether in whole or ground form; in the second application, potassium bicarbonate is incorporated into soluble coffee granules; and in the third, potassium bicarbonate is incorporated into a brewed coffee beverage. In all three applications, the resulting brewed coffee beverage (following the brewing process in the first and second applications) exhibits two key characteristics: 1) diminished acidity, denoted by higher pH levels, thereby reducing the potential adverse effects on gastrointestinal (GI) health associated with frequent consumption; and 2) reduced turbidity, indicated by lower Nephelometric Turbidity Unit (NTU) values, yielding a visually clearer and aesthetically appealing beverage. The precise adjustment of final pH and turbidity (NTU) is achievable through the modulation of potassium bicarbonate levels mixed with the coffee beans or granules.

As for the first characteristic, potassium bicarbonate, a nutritional supplement, dissolves upon contact with water to yield K⁺ (potassium) and HCO3⁻ (bicarbonate), the bicarbonate being a base which can neutralize acids. The bicarbonate reacts with acids extracted from coffee beans during brewing, leading to their neutralization and consequent elevation of the final brewed coffee's pH (reduced acidity).

As for the second characteristic, when potassium bicarbonate is mixed with coffee beans or soluble coffee prior to brewing, or directly to the brewed coffee beverage, the clarity of the brewed coffee beverage increases (decreased turbidity). The extent of which the clarity increases compared to the baseline of typical coffee (pH of around 5.0) becomes larger as the brewed beverages cool.

Potassium bicarbonate is an FDA-classified GRAS (generally recognized as safe) substance. Although potassium bicarbonate has not previously been recommended for use in coffee as a suitable acid-reducing agent, empirical findings demonstrate its exceptional efficacy with minimal adverse effects on the treated beverage's taste, aroma, or overall likeness. As mentioned in Section 0010, other acid-reducing compounds have significant short comings or downsides when used to create low-acid coffee products.

Summarizing the proposed invention, one aspect of the present invention is directed to a process for creating a coffee bean (ground or whole bean) product which allows brewing of a coffee beverage with decreased acidity and turbidity. The process includes providing a quantity of roasted coffee beans having a total bean weight, providing potassium bicarbonate at an amount of up to 3 percent of the total bean weight and preparing a mixture of the quantities of roasted coffee beans and potassium bicarbonate by mixing methods such as, but not limited to tumbling or stirring. Preparing the coffee beans and potassium bicarbonate mixture may include processing the potassium bicarbonate to a uniform powder of <0.5 mm granule size prior to mixing. The potassium bicarbonate may be processed to a uniform powder by, but not limited to, grinding, pulverizing, or crushing. Preparing a coffee and potassium bicarbonate mixture may include adding the potassium bicarbonate to a binder or excipient and coating the roasted coffee beans with the potassium bicarbonate dissolved in the binder or excipient. The binder or excipient may be propylene glycol or glycerin. The binder or excipient may include water.

Another aspect of the present invention is directed to a process for creating a soluble instant coffee product which allows brewing of a brewed coffee beverage with decreased acidity and turbidity. The process includes providing a quantity of soluble coffee granules having a total granular weight, providing potassium bicarbonate at an amount of up to 10 percent of the total soluble coffee granular weight and preparing a mixture of the quantities of soluble coffee granules and the potassium bicarbonate by mixing methods such as, but not limited to tumbling or stirring. Preparing the soluble coffee granule and potassium bicarbonate mixture may include processing the potassium bicarbonate to a uniform powder of <0.5 mm granule size prior to mixing. The potassium bicarbonate may be processed to a uniform powder by, but not limited to, grinding, pulverizing, or crushing. Preparing a coffee and potassium bicarbonate mixture may include adding the potassium bicarbonate to a binder or excipient and coating the roasted coffee beans with the potassium bicarbonate dissolved in the binder or excipient. The binder or excipient may be propylene glycol or glycerin. The binder or excipient may include water.

Another aspect of the present invention is directed to a process for creating a potassium bicarbonate and carrier product, which can be mixed into a brewed coffee beverage to decrease its acidity and turbidity. The process includes mixing potassium bicarbonate with a carrier and providing dosing instruction which equate to adding up to 1% of an active ingredient potassium bicarbonate by weight to 100 grams of brewed coffee (with 100 mL of coffee beverage weighing approximately 100 grams). The carrier may be, but is not limited to, maltodextrin, dextrose or cellulose.

### BRIEF DESCRIPTION OF DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a graph showing turbidity measurements (NTU) made at specific temperatures of coffee beverages at four different pH levels (all adjusted with potassium bicarbonate);

FIG. 2 is a graph showing pH measurements taken after the addition of potassium bicarbonate, sodium bicarbonate, and calcium carbonate directly to brewed coffee;

FIG. 3 is a graph showing the effects of adding various amounts of potassium bicarbonate to ground coffee beans prior to brewing and directly to brewed coffee after brewing;

FIG. 4 is a flowchart showing the steps for the production of a packaged mixture of potassium bicarbonate and coffee beans (whole or ground) according to the present invention;

FIG. 5 is a flowchart showing the steps for the production of a package mixture of potassium bicarbonate and soluble coffee according to the present invention; and

FIG. 6 is a flowchart showing the steps for the production of a packaged formulation of potassium bicarbonate which can be added directly to brewed coffee;

### DETAILED DESCRIPTION OF THE INVENTION

While various aspects and features of certain embodiments have been summarized above, the following detailed description illustrates a few exemplary embodiments in further detail to enable one skilled in the art to practice such embodiments. The described exemplary embodiments are provided for informational purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

As this invention is susceptible to embodiments of many different forms, it is intended that the present disclosure be considered as an example of the principles of the invention and not intended to limit the invention to the specific embodiments shown and described.

The specific utilization of potassium bicarbonate is key to our process, as it is an ideal supplement not used previously in the coffee market space. As mentioned, potassium bicarbonate is a nutritional supplement and falls in the FDA “generally recognized as safe” (GRAS) category. FDA Code of Federal Regulations Title 21 states that potassium bicarbonate is included in the GRAS category if used within its good manufacturing practice conditions of use, as outlined here: Used as 1) a formulation aid (§ 170.3(o)(14)); 2) nutrient supplement (§ 170.3(o)(20)); 3) pH control agent (§ 170.3(o)(23)); and 4) processing aid as (§ 170.3(o)(24)). As part of our proposal, potassium bicarbonate is used as a pH control agent (as in (§ 170.3(o)(23))), and as a method to decrease turbidity of a coffee beverage. The latter use is novel in the coffee space: potassium bicarbonate (an ideal ingredient for the regulation of acidity in coffee, as described above), also increases the clarity and appeal of the brewed coffee beverage by decreasing its turbidity, thereby giving this idea an additional advantage for use in brewing coffee.

Upon contact with water, potassium bicarbonate hydrolyses (dissolves) to form potassium ions [K⁺] and bicarbonate-ions [HCO3⁻], which are both electrolytes. The latter, the bicarbonate ion, has a pKa of 10.3 and is a base able to neutralize acid. Applied to our coffee brewing idea, the bicarbonate ion reacts with acids extracted from the coffee beans/grounds, neutralizing them, and increasing the pH of the final brewed coffee beverage (making it less acidic). The benefits of potassium bicarbonate over other acid-reducing supplements are that potassium bicarbonate is a mostly flavorless addition (as opposed to sodium bicarbonate, also known as baking soda, which has a strongly “salty” taste caused by the sodium) and is highly water soluble (as opposed to calcium carbonate see section 0010).

In addition to creating a low-acidity coffee beverage with a taste characterizable as “smooth”, the invention is also intended to address the common complaint of coffee drinkers experiencing coffee-induced upset stomach. It might furthermore serve to be beneficial to people affected by GERD, or other GI-related issues. The invention fulfills the need for a coffee product with a pH greater than that of typical coffee products, providing a significant reduction in acid content.

The first two proposed processes consist of processing the potassium bicarbonate to a powder (<0.5 mm) and mixing the potassium bicarbonate powder with coffee beans (whole or ground) or soluble coffee granules prior to brewing. The resulting product will enable consumers to brew coffee, creating a brewed coffee beverage which has 1) increased pH and thus decreased acidity and 2) decreased turbidity and thus increased clarity. Thus, creating a clearer lower acid coffee beverage.

Commonly, other brands marketing products as ‘low acid’ make use of non-conventional roasting processes, which tend to roast at lower temperatures for extended time to control for acid in the final product. This approach only marginally decreases the pH and presence of certain acid types (such as chlorogenic acid) coffee but, but these products still contain abundant other acid types. Many of the existing brands market themselves as ‘low acid’ or even ‘acid free’ a clear misrepresentation of their product's benefit. Most of these products have measured acidity levels (pH) that fall between a pH of 5 and 5.5, a similar level to the typical pH of standard brewed coffee of 4.8-5.2.

For the first and second proposed embodiments of this invention, the potassium bicarbonate supplement is processed to a powder (<0.5 mm level) via, but not limited to, grinding, crushing, or pulverizing uniformly (e.g., but not limited to processing through a burr grinder or mortar and pestle).

In one particular embodiment of this invention, the potassium bicarbonate powder is combined with roasted coffee beans (ground or whole) at a weight-based range greater than zero (0) and up to three (3) percent (%) potassium bicarbonate to roasted coffee, or in other terms >zero (0) to ≤three (3) grams of potassium bicarbonate to one hundred (100) grams of roasted coffee beans. The naturally occurring oils on and the porous nature of the coffee bean (whole or ground) surface help the potassium bicarbonate adhere.

In a second particular embodiment, the potassium bicarbonate powder is combined with soluble coffee granules at a weight-based range of greater than zero (0) and up to ten (10) percent (%) potassium bicarbonate to soluble coffee granules, or in other terms >zero (0) to ≤ten (10) grams of potassium bicarbonate to one hundred (100) grams of soluble coffee granules.

In both the first and second embodiments (as described in 0038 and 0039), the potassium bicarbonate and coffee bean (embodiment 1) or soluble coffee (embodiment 2) combinations are then mixed thoroughly to distribute the potassium bicarbonate equally (e.g., via but not limited to tumble, agitation, or stirrer mixing).

In both the first and second embodiments (as described in 0038 and 0039), the potassium bicarbonate powder can also be dissolved in an excipient or a binder (e.g., but not limited to glycerol, propylene glycol, or water) prior to its combination with coffee beans (embodiment 1) or soluble coffee (embodiment 2). In this case of mixture with excipient or binder, the potassium bicarbonate distributed among the coffee beans via but not limited to spraying or tumbling.

In a third particular embodiment, the potassium bicarbonate powder is combined with brewed coffee, made from either soluble coffee of coffee beans (whole or ground) at a weight-based range of greater than zero (0) and up to one (1) percent (%) potassium bicarbonate to brewed coffee, or in other terms >zero (0) to ≤one (1) grams of potassium bicarbonate to one hundred (100) grams of brewed coffee, (100 g of brewed coffee is roughly equivalent to 100 mL). In the third embodiment, the potassium bicarbonate powder can also be added to a carrier additive given the small amount required on weight basis (e.g., but not limited to maltodextrin, dextrose, or cellulose). The resulting product with potassium bicarbonate as the active ingredient can then be added into a brewed coffee beverage and mixed thoroughly to dissolve the potassium bicarbonate fully (e.g., via but not limited to stirring).

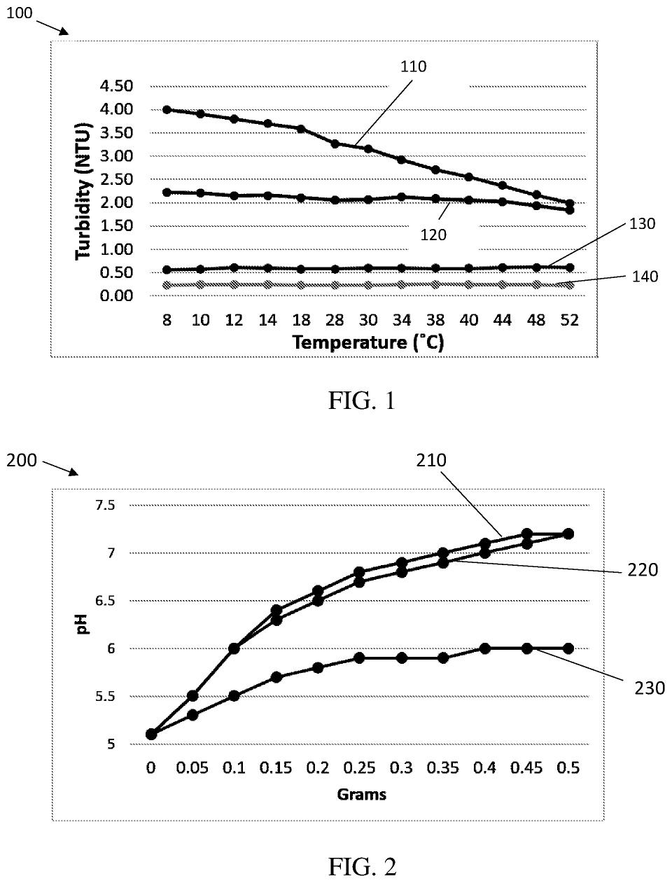

Ultimately, the invention will be turned into a roasted coffee product (ground or whole bean), as in embodiment 1, or soluble coffee product, as in embodiment 2, that can be purchased as a substitute for any packaged coffee product, whether whole bean, ground, soluble. The resulting product in embodiment 3 will allow the addition of the product (containing the active ingredient potassium bicarbonate), to any type of brewed coffee. In all implementations, the introduction of potassium bicarbonate into the coffee enables adjustment of the final brewed beverage's acidity (pH) and turbidity (NTU) values. With the above ranges of potassium bicarbonate, the pH of brewed coffee can be adjusted to a range between its initial pH (typically 5.0) and approximately pH 7.5, and the turbidity levels (NTU) can be decreased significantly below the levels of the initial brewed coffee. The exact turbidity decrease depends on the starting NTU levels of the brewed coffee prior to the addition of potassium bicarbonate, which typically lies between 3-5 NTU. FIG. 1 shows that the turbidity values of a brewed coffee beverage adjusted with potassium bicarbonate to a pH of 6.5 are ≤0.25 NTU at any temperature between 8-52 degrees C.

FIG. 1 is graph 100 showing turbidity measurements of brewed made at specific temperatures made with a LaMotte 2020we Turbidimeter on brewed coffee at its initial unadjusted pH of 5.2 (110), and following increasing the pH with potassium bicarbonate to 5.5 pH (120), 6.0 pH (130), and 6.5 pH (140). An Apera Instruments PH20 pH meter was used to measure pH in all figures. As a standard cup of coffee (with a typical pH between 4.9-5.2, here being 5.2 (110)) cools following brewing with hot water, its clarity decreases and turbidity increases. However, when the pH of the brewed coffee is increased by addition of potassium bicarbonate, the turbidity is decreased. Even at cold temperatures, the NTU values from a brewed coffee starting at a pH of 5.2 decrease from 4.00 NTU (110) as pH is increased: to 2.22 NTU (pH 5.5), to 0.57 NTU (pH 6.0), to 0.23 NTU (pH 6.5), as shown in FIG. 1. This results in a much clearer and less turbid brewed coffee beverage, which is visually appealing to the consumer.

FIG. 2 is graph 200 showing pH measurements taken after the addition of potassium bicarbonate (210), sodium bicarbonate (220), and calcium carbonate (230) directly to brewed coffee. This data was generated by adding the indicated grams of supplement to 240 mL of brewed coffee (˜1 cup) and measuring the resultant pH. While both potassium bicarbonate and sodium bicarbonate neutralize the acidity of the coffee with similar efficacy, calcium carbonate did not as it is not easily soluble in water and forms a white precipitate. Comparing potassium bicarbonate and sodium bicarbonate, the cations formed upon dissolving in water are K⁺ (potassium) and Na⁺ (sodium), respectively. While K⁺ is mainly flavorless, not impacting the taste of the coffee beverage, Na⁺ has a strong “salty” flavor, strongly impacting the flavor of the coffee in an undesirable way (just like the Na⁺ from NaCl, which is ‘table salt’). Thus, potassium bicarbonate is an ideal and superior ingredient to decrease the acidity of coffee, without negatively impacting its flavor.

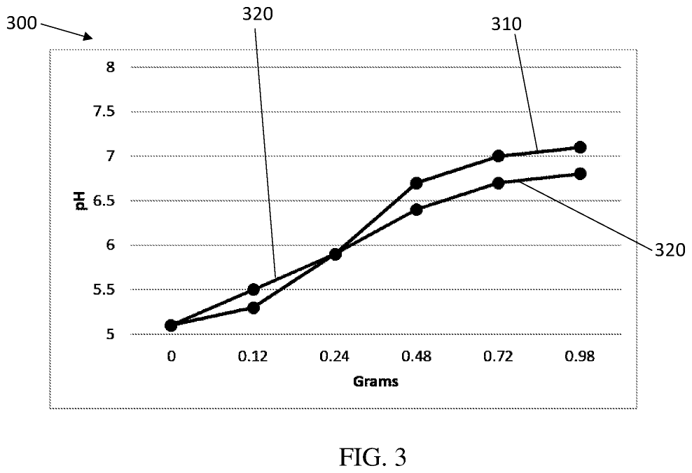

FIG. 3 is a graph 300 showing the effects of adding various amounts of potassium bicarbonate to coffee prior to brewing and after brewing. This data was generated by adding the indicated grams of supplement either directly to 24 g of ground coffee beans prior to brewing with 2 cups of water (310), or to the directly to the resulting brewed coffee beverage using the same brewing conditions (320). Note the crossing of graph lines at 0.24 grams added. The trend shows that the neutralizing agent has similar effects at similar added levels in both scenarios. This data highlights that the time point of when the neutralizing agent is added is not critical to its effect.

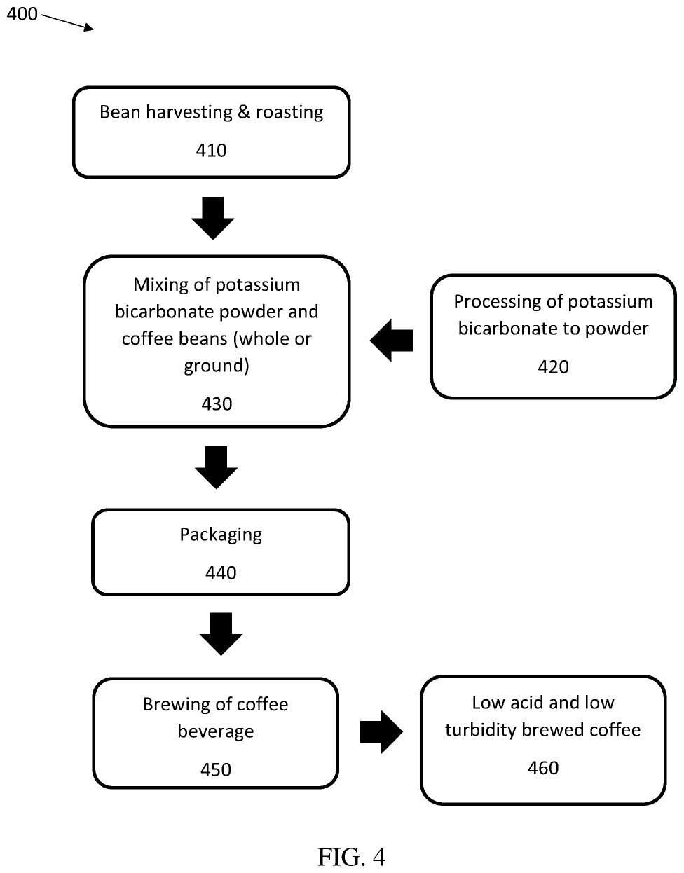

FIG. 4 shows the first embodiments of a high-level process flowchart 400 is directed to a process of decreasing the turbidity and acidity of coffee brewed from coffee beans (whole or ground). It begins at 410 with the production of coffee from the harvesting and roasting of the beans to the brewing of the beverage 450. The additive, potassium bicarbonate is processed to create a powder (420) as described in [0037] and mixed with roasted coffee beans (either ground or whole) at an amount of up to 3% of the total coffee bean weight (430), as described in [0038], prior to packaging (440). The final product would be brewed (450), creating low acid and low turbidity brewed coffee beverage (460).

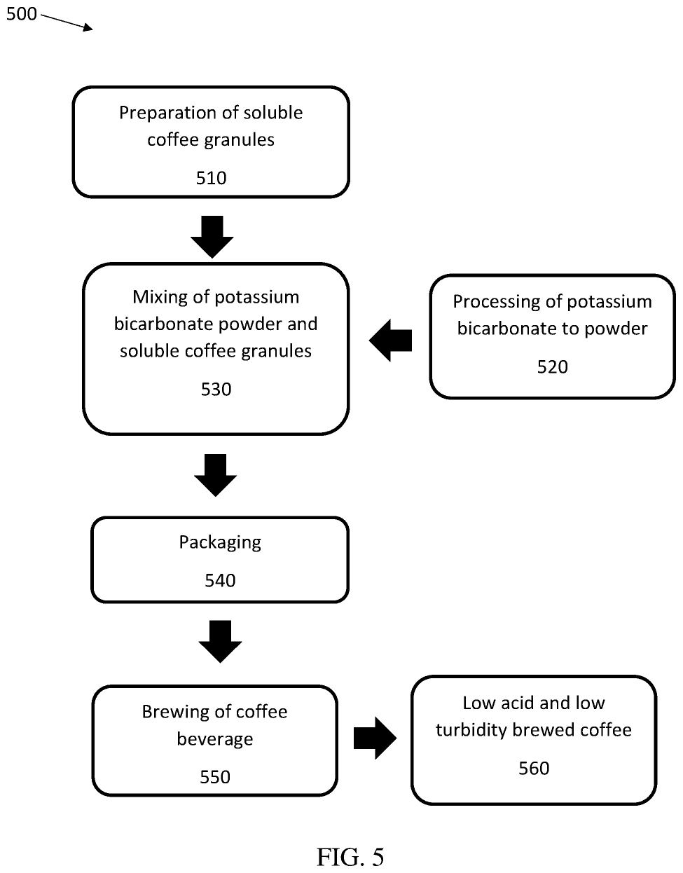

Another aspect of the invention shown in FIG. 5 is directed to a process 500 for decreasing turbidity and acidity of a brewed soluble coffee beverage. The process includes first providing a quantity of soluble coffee granules (510), the soluble coffee granules having a total coffee granular weight. The process includes processing the potassium bicarbonate to create a powder (520), as described in [0037], and mixing the potassium bicarbonate to the soluble coffee granules at an amount of up to 10% of the total coffee granular weight (530), as described in [0039]. Following the packaging of this mixture (540), the soluble coffee can be brewed (550) by adding water, creating low acid and low turbidity brewed coffee beverage (560).

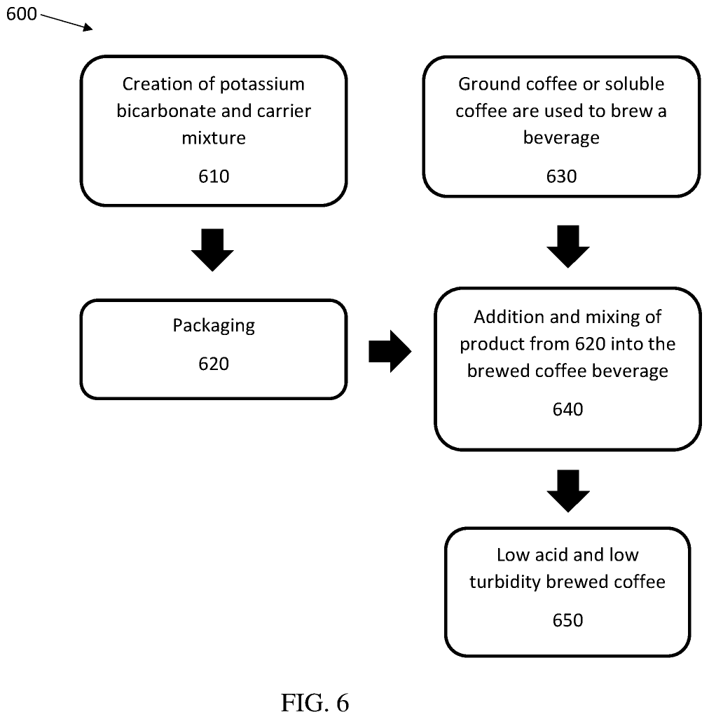

FIG. 6 shows a flowchart 600 in which potassium bicarbonate as the active ingredient is mixed with a carrier (for example but not limited to dextrose or cellulose) (610), and this potassium bicarbonate and carrier mixture is packaged (620). Following the consumer brewing a coffee beverage (630), the potassium bicarbonate and carrier mixture is added to the brewed coffee (640). Creating a final brewed coffee product which has decreased acidity and turbidity (650).

A variety of methods can be used by the consumer to brew coffee, including all common methods for preparing coffee including but not limited to drip coffee, French press, espresso machine, pour over and cold brew.

When the coffee beverage is made through the process of cold brewing, the temperature of the water is kept well below 175 degrees F. (80 C). Otherwise, the preferred temperature for water used in brewing is at least 175 degrees F. (80 C). Since many modifications, variations, and changes in detail can be made to the described embodiments of the invention, it is intended that all matters in the foregoing description and shown in the accompanying drawings be interpreted as illustrative but not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

As far as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A process for creating a coffee beans, ground or whole bean, product which allows brewing of a brewed coffee beverage with decreased acidity and turbidity, the process comprising:
providing a quantity of roasted coffee beans having a total bean weight;
providing potassium bicarbonate at an amount of up to 3 percent of the total bean weight of the roasted coffee beans weight; and
preparing a coffee and potassium bicarbonate mixture of the quantity of roasted coffee beans and the potassium bicarbonate.

2. The process according to claim 1 wherein preparing a coffee and potassium bicarbonate mixture includes:
processing the potassium bicarbonate to a uniform powder of <0.5 mm granule size.

3. The process according to claim 2 wherein the potassium bicarbonate is processed to a uniform powder by grinding, pulverizing or crushing.

4. The process according to claim 1 wherein preparing the coffee and potassium bicarbonate mixture is performed by a mixing method of tumbling or stirring.

5. The process according to claim 1 wherein preparing a coffee and potassium bicarbonate mixture includes:
adding the potassium bicarbonate to a binder or excipient; and
coating the quantity of roasted coffee beans with the potassium bicarbonate dissolved in the binder or excipient.

6. The process according to claim 5 wherein the binder or excipient is propylene glycol.

7. The process according to claim 5 wherein the binder or excipient is glycerin.

8. The process according to claim 5 wherein the binder or excipient includes water.

9. A process for creating a soluble instant coffee product which allows brewing of a brewed coffee beverage with decreased acidity and turbidity, the process comprising:
providing a quantity of soluble coffee granules having a total granular weight;
providing potassium bicarbonate at an amount of up to 10 percent of the total granular weight of the soluble coffee granules; and
preparing a soluble coffee and potassium bicarbonate mixture of the quantify of soluble coffee granules and the potassium bicarbonate.

10. The process according to claim 9 wherein preparing a coffee and potassium bicarbonate mixture includes:
processing the potassium bicarbonate to a uniform powder of <0.5 mm granule size.

11. The process according to claim 10 wherein the potassium bicarbonate is processed to a uniform powder by grinding, pulverizing or crushing.

12. The process according to claim 9 wherein preparing the soluble coffee and potassium bicarbonate mixture is performed by a mixing method of tumbling or stirring.

13. The process according to claim 9 wherein preparing a coffee and potassium bicarbonate mixture includes:
adding the potassium bicarbonate to a binder or excipient; and
coating the quantity of soluble coffee granules with the potassium bicarbonate dissolved in the binder or excipient.

14. The process according to claim 13 wherein the binder or excipient is propylene glycol.

15. The process according to claim 13 wherein the binder or excipient is glycerin.

16. The process according to claim 13 wherein the binder or excipient includes water.

17. A process for creating a potassium bicarbonate and carrier product, which can be mixed into a brewed coffee beverage to decrease its acidity and turbidity, the process comprising:
mixing potassium bicarbonate with a carrier; and
providing dosing instruction which equate to adding up to 1% of the active ingredient potassium bicarbonate to 100 grams of brewed coffee beverage, with 100 mL of coffee beverage weighing approximately 100 grams.

18. The process according to claim 17 wherein the carrier is maltodextrin.

19. The process according to claim 17 wherein the carrier is dextrose.

20. The process according to claim 17 wherein the carrier is cellulose.
